(19) United States
(12) Patent Application Publication
(10) Pub. No.: US 2005/0046593 A1
(43) Pub. Date: Mar. 3, 2005

(54) Reconfigurable sensor signal demodulation system

(76) Inventors: Bhalchandra R. Tulpule, Farmington, CT (US); Robert K. Thornton, Coventry, CT (US); William C. Rogers, Suffield, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/650,923

(22) Filed: Aug. 28, 2003

(51) Int. Cl. G08C 19/06

(52) U.S. Cl. 340/870.36

(57) ABSTRACT

A reconfigurable position detection system demodulates an LVDT sensor via software in a microprocessor instead of hardware. The LVDT output is sampled and undergoes a root mean square calculation or an averaging calculation to obtain an LVDT position value. The lack of hardware demodulation circuitry allows the system to be reconfigured to accept sensors other than LVDT sensors by modifying the software in the microprocessor, without requiring any changes to hardware components in the system.

### TECHNICAL FIELD

The present invention is directed to position measurement, and more particularly to a position measurement system that is reconfigurable to support multiple types of sensors that provide position information.

### BACKGROUND OF THE INVENTION

Linear variable differential transformer (LVDT) sensors are commonly used in industrial and commercial applications to provide accurate position information to a controller. For example, in an aircraft, accurate detection of an actuator position is essential to ensure that the controller will operate an aircraft component precisely. In other words, the position of any user-controlled input device must be detected accurately to ensure proper operation of the user application. LVDT sensors are therefore popular due to their accuracy and reliability.

However, currently known systems using LVDT sensors require hardware demodulation circuitry. Although hardware demodulation circuits are readily available, they are costly and cannot be reconfigured to support sensors other than LVDT sensors. This restricts systems using LVDT sensors from supporting other types of sensors.

There is a need for a less-costly system that allows use of LVDT sensors while still preserving enough flexibility to allow the use of other sensors as well.

### SUMMARY OF THE INVENTION

The present invention is directed to a reconfigurable system that conducts LVDT demodulation via software and not hardware. The LVDT output is sent through a microprocessor that calculates an LVDT position value from the LVDT output. In one embodiment, one secondary coil output from the LVDT is sampled and undergoes a root mean square calculation to obtain a LVDT position value. In another embodiment, outputs from two secondary coils in the LVDT are sampled and undergo an averaging calculation to obtain the LVDT position value.

The omission of hardware demodulation circuitry allows the system to accept sensors other than the LVDT sensors by modifying the software in the microprocessor, without requiring any changes to hardware components in the system. As a result, the inventive system provides additional flexibility while also reducing costs due to the elimination of excess hardware.

### BRIEF DESCRIPTION OF THE DRAWINGS

FIG. 1 is a block diagram illustrating a system according to one embodiment of the invention;

FIG. 2 is a flow diagram illustrating a method according to one embodiment of the invention;

FIG. 3 is a graph illustrating results of one embodiment of the invention.

### DETAILED DESCRIPTION OF THE EMBODIMENTS

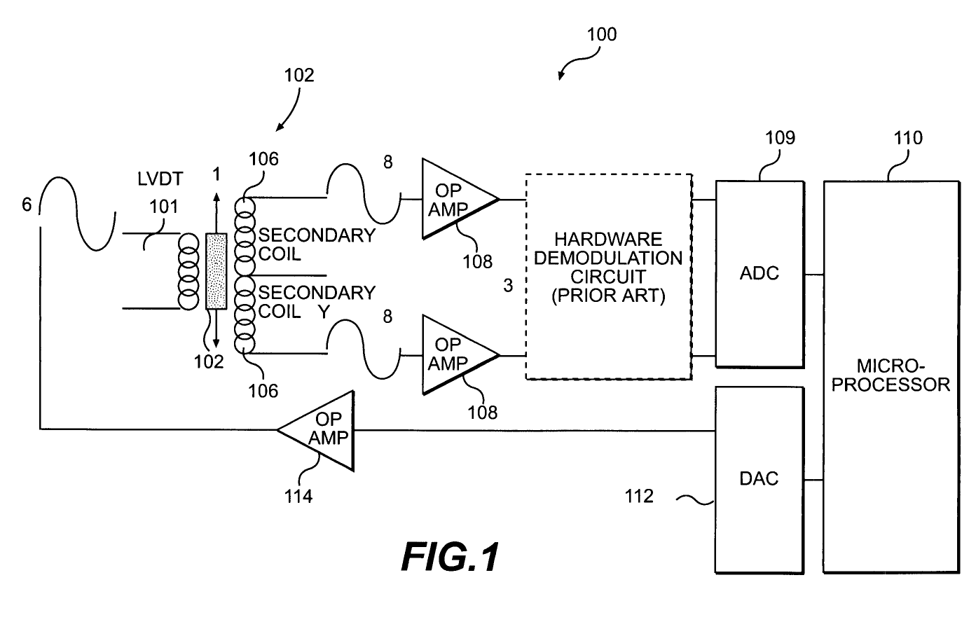

FIG. 1 is a representative block diagram illustrating a system 100 according to one embodiment of the invention. Generally, the inventive system eliminates LVDT hardware demodulation circuitry by incorporating software to conduct the demodulation rather than relying on hardware.

Referring to FIG. 1, the system 100 includes an LVDT sensor 102 having a movable core 102 that moves between a primary coil 104 and two secondary coils 106. The core 102 can be coupled to any user-operable input device (e.g., a throttle, a knob, etc.) whose position reflects a command corresponding to a desired operational outcome (e.g., aircraft speed, aircraft altitude, wing position, etc.). The position of the core 102 determines the signal sent to the microprocessor 106, which in turn interprets the signal so that the command can be executed. As is known in the art, the output from the LVDT sensor 102 will be an AC coupled signal, which provides immunity from noise and stabilizes the signal.

More particularly, as the core 102 moves in the directions shown by the arrows, it changes the magnetic coupling between the primary coil 104 and the secondary coils 106, thereby changing output signals generated by the secondary coils 106 in response to an LVDT excitation at the primary coil. If the user does not move the input device, thereby keeping the core 102 stationary, the secondary coils 106 will generate one set of sine waves. If the user moves the core 102 over time, however, a LVDT carrier signal will be superimposed on the sine wave. The LVDT carrier signal eventually must be removed in a demodulation process to retrieve the original sine wave.

The LVDT sensor 102 itself can be integrated into the input device (not shown) to ensure that the position of the input device consistently and reliably generates commands that reflect the device's position.

Sine waves from both of the secondary coils 106 are sent though operational amplifiers 108, which serve as a common analog input interface that can be used to connect sensors other than the LVDT sensor 102. In conventional systems, a hardware demodulation circuit (shown in phantom) would be disposed between the operational amplifiers 108 and an A/D converter 109. In the inventive system 100, however, the demodulation functions normally conducted by the hardware demodulation circuit are conducted by software in a microprocessor 110.

Thus, as shown in FIG. 1, the sine wave outputs of the secondary coils 106 are sent directly from the operational amplifiers 108 to the A/D converter 109 without being sent through any demodulation circuit. Generally, the microprocessor 110 synchronizes the generation of the LVDT excitation sinusoid, sampling of the LVDT, and position calculation (e.g., through root mean square calculations). The LVDT excitation sinusoid itself is generated by the microprocessor 110 and a D/A converter 112. Although FIG. 1 shows sending the D/A converter 112 output through an operational amplifier 114, this operational amplifier 114 is optional in the system. The fidelity of the LVDT excitation signal depends on the number of updates per excitation cycle and the resolution of the D/A converter 112.

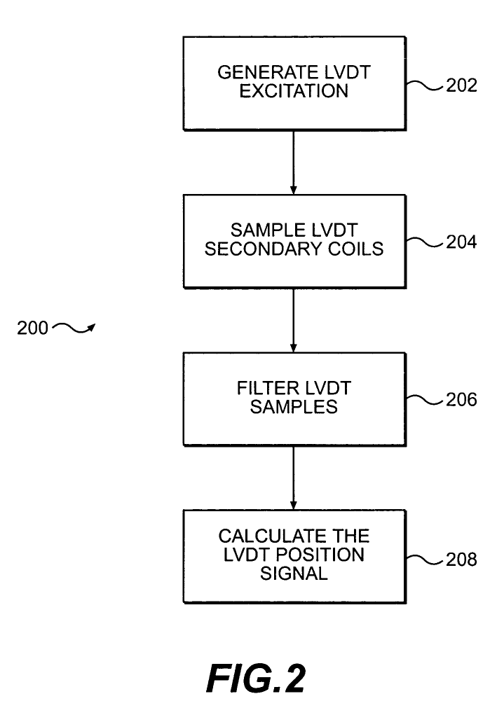

FIG. 2 is a flow diagram illustrating a method 200 for calculating position according to one embodiment of the invention. First, the system 100 generates an LVDT excitation signal and applies it to the primary coil 104 of the LVDT 102 (block 202). In one embodiment, the LVDT excitation signal is generated only during LVDT sampling, reducing power consumption and processing requirements.

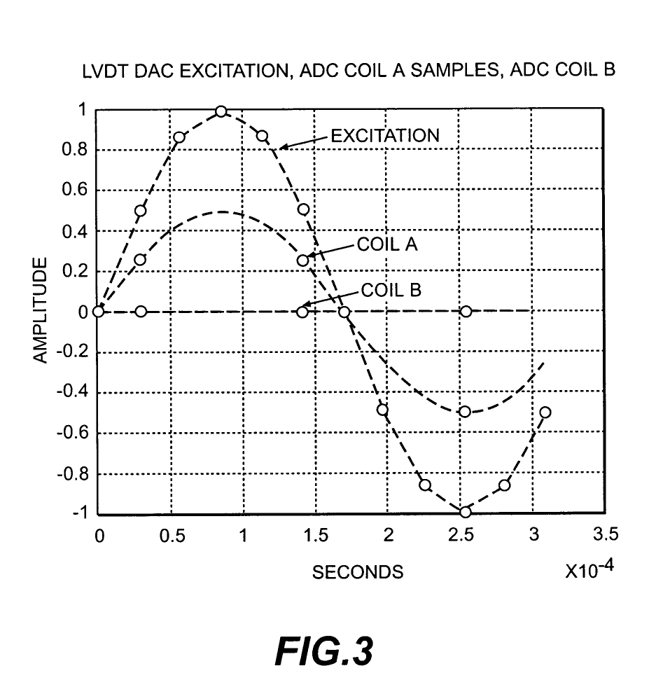

Next, the microprocessor 110 samples the sine wave outputs of the secondary coils 108 in the LVDT 102 (block 204). The specific number of samples taken can vary as long as there is a sufficient number to reconstruct the secondary coil outputs and determine LVDT position with a desired level of accuracy. In one embodiment, a minimum of three evenly spaced samples over one sine wave cycle to obtain an LVDT position accuracy of around 0.25%. The sine wave outputs will vary over time, so the number of samples to achieve a desired level of accuracy may also vary. An example of the sampling step (block 204) is shown in FIG. 3, which illustrates one example of the LVDT excitation signal and the output signals from both of the secondary coils 108.

Once the secondary coil outputs have been sampled, the microprocessor 110 may filter the samples (block 206) to selectively pass only the frequency of the LVDT carrier signal. This is particularly useful in environments containing high frequency normal-mode noise because it improves the normal-mode noise rejection of the system, separating the LVDT signals from the environmental noise.

The filtered samples are then used to calculate the LVDT position (block 208). In one embodiment, the LVDT position is calculated by the microprocessor 110 using a root mean square (RMS) calculation according to the following equation:

$${LVDT}_{RMS} = {( \frac{1}{N} {\sum }_{i = 1}^{N} {( {X}_{i} - M )}^{2} )}^{\frac{1}{2}} \qquad Equation 1$$

where xi is a sample from a first LVDT secondary coil, m is the mean of the signal, and N is the number of samples taken. This embodiment can calculate the LVDT based on an output from only one of the two secondary coils 108. In this example, the RMS calculation provides a statistical standard deviation with a mean value of zero.

Alternatively, the microprocessor 110 calculates the LVDT position by an averaging calculation rather than an RMS calculation. this has the advantage of eliminating high processing overhead caused by calculating the square root function in Equation 1. The averaging calculation can be conducted according to the following equation:

$${LVDT}_{POS} = \frac{{( {\sum }_{i = 1}^{N} {X}_{i}^{2} )}^{\frac{1}{2}} - {( {\sum }_{i - 1}^{N} {y}_{i}^{2} )}^{\frac{1}{2}}}{{( {\sum }_{i = 1}^{N} {X}_{i}^{2} )}^{\frac{1}{2}} + {( {\sum }_{i - 1}^{N} {y}_{i}^{2} )}^{\frac{1}{2}}} \qquad Equation 2$$

where yi is a sample from a second LVDT secondary coil. Note that in this embodiment, samples from both secondary coils in the LVDT are used to calculate the LVDT position and the mean of the signal is disregarded. In Equation 2, each sample is squared and summed before calculating the square root, resulting in an RMS value for each secondary coil. The LVDT position is then calculated via a ratiometric calculation.

Note that Equation 2 is immune to changes in excitation amplitude by generating a relative measure of an LVDT difference signal versus an LVDT sum signal. Dividing the LVDT difference by the LVDT sum improves common-mode noise rejection while reducing processing time when compared to conventional RMS calculation.

Once the microprocessor 110 conducts the position calculation, it generates the LVDT position output and sends the output to the D/A converter 112 to convert the microprocessor output 110 to an analog LVDT excitation signal. This LVDT excitation signal is then sent to the primary coil 104 of the LVDT 102.

Because demodulation of the secondary coil outputs is conducted entirely by software in the microprocessor 110, any changes in the LDVT frequency (e.g., for different applications) will not require any changes in the system components, as would be the case if the demodulation was conducted via hardware circuitry. Further, the lack of hardware demodulation circuitry allows the system 100 to be reconfigured to accept other types of analog sensors. As can be seen in FIG. 1, the secondary coil outputs from the LVDT are sent directly to the A/D converter 109 without any demodulation. This allows the system to use a common analog input circuit to send the signals from the sensor to the microprocessor 110 for demodulation. Thus, the system 100 can be easily reconfigured to accept sensors other than the LDVT sensor 102 by simply modifying the program executed by the microprocessor 110 to interpret the signals sent by the new sensor, without any hardware modifications.

As a result, the inventive system provides demodulation circuitry that can be reconfigured to support sensors other than LVDT sensors. By incorporating the LVDT demodulation function on software rather than hardware, the system 100 can be significantly less expensive due to the elimination of the hardware and frees up hardware for other purposes.

It should be understood that various alternatives to the embodiments of the invention described herein may be employed in practicing the invention. It is intended that the following claims define the scope of the invention and that the method and apparatus within the scope of these claims and their equivalents be covered thereby.

1. A reconfigurable sensing system, comprising:
a linear variable differential transformer (LVDT) sensor that generates an LVDT sensor output;
a microprocessor that demodulates the LVDT output and calculates a position signal from the LVDT output; and
a common sensor input interface between the LVDT sensor and the microprocessor, wherein the common sensor input interface is adapted to accommodate at least one sensor other than the LVDT sensor.

2. The reconfigurable sensing system of claim 1, wherein the common sensor input interface comprises at least one operational amplifier.

3. The reconfigurable sensing system of claim 2, wherein the common sensor input interface comprises a first operational amplifier that receives a first secondary coil output from the LVDT sensor and a second operational amplifier that receives a second secondary coil output from the LVDT sensor.

4. The reconfigurable sensing system of claim 1, further comprising an analog-to-digital converter between the common sensor interface and the microprocessor.

5. The reconfigurable sensing system of claim 1, wherein the microprocessor conducts a root mean square calculation on the LVDT sensor output to calculate the position signal.

6. The reconfigurable sensing system of claim 1, wherein the microprocessor conducts a ratiometric calculation on the LVDT sensor output to calculate the position signal.

7. The reconfigurable sensing system of claim 6, wherein the LVDT sensor output comprises a first secondary coil output and a second secondary coil output, and wherein the ratiometric calculation divides a difference signal calculated from the first and second secondary coil outputs by a sum signal calculated from the first and secondary coil outputs.

8. The reconfigurable sensing system of claim 1, further comprising a filter that isolates an LVDT carrier frequency in the LVDT sensor output.

9. The reconfigurable sensing system of claim 1, further comprising a digital-to-analog converter that converts an output from the microprocessor to generate an LVDT excitation signal to be sent to the LVDT sensor.

10. The reconfigurable sensing system of claim 8, further comprising an operational amplifier that receives the output of the digital-to-analog converter.

11. A reconfigurable sensing system, comprising:
a linear variable differential transformer (LVDT) sensor that generates an LVDT sensor output;
a microprocessor that demodulates the LVDT output and calculates a position signal from the LVDT output;
a first operational amplifier that receives a first secondary coil output from the LVDT sensor and a second operational amplifier that receives a second secondary coil output from the LVDT sensor, the first and second operational amplifiers forming a common sensor input interface adapted to accommodate at least one sensor other than the LVDT sensor and disposed between the LVDT sensor and the microprocessor;
an analog-to-digital converter that receives outputs from the first and second operational amplifiers and sends an input signal to the microprocessor; and
a digital-to-analog converter that converts an output from the microprocessor to generate an LVDT excitation signal to be sent to the LVDT sensor.

12. The reconfigurable sensing system of claim 11, wherein the microprocessor conducts a root mean square calculation on the LVDT sensor output to calculate the position signal.

13. The reconfigurable sensing system of claim 11, wherein the microprocessor conducts a ratiometric calculation on the LVDT sensor output by dividing a difference signal calculated from the first and second secondary coil outputs by a sum signal calculated from the first and secondary coil outputs to calculate the position signal.

14. The reconfigurable sensing system of claim 11, further comprising a filter that isolates an LVDT carrier frequency in the LVDT sensor output.

15. A method of position detection, comprising:
generating an LVDT excitation signal;
generating an LVDT sensor output in response to the LVDT excitation signal;
converting the LVDT sensor output to a digital LVDT signal;
demodulating the digital LVDT signal; and
calculating a position signal from the demodulated digital LVDT signal; and
converting the position signal to an analog signal to generate an LVDT excitation signal to be sent to the LVDT sensor.

16. The method of claim 15, wherein the converting step comprises sampling the LVDT sensor output.

17. The method of claim 15, further comprising filtering the LVDT sensor output to isolate an LVDT carrier frequency.

18. The method of claim 15, wherein the step of calculating a position signal comprises conducting a root mean square calculation on the digital LVDT signal.

19. The method of claim 15, wherein the step of calculating a position signal comprises conducting a ratiometric calculation on the digital LVDT signal by dividing a difference signal calculated from first and a second secondary coil outputs by a sum signal calculated from the first and secondary coil outputs.
